(19) United States
(12) Patent Application Publication
(10) Pub. No.: US 2012/0324238 A1
(43) Pub. Date: Dec. 20, 2012

(54) INFORMATION PROCESSING APPARATUS, VERIFICATION METHOD, AND STORAGE MEDIUM STORING VERIFICATION PROGRAM

(75) Inventor: Shigeya Senda, Shizuoka (JP)

(73) Assignee: RICOH COMPANY, LTD., Tokyo (JP)

(21) Appl. No.: 13/483,627

(22) Filed: May 30, 2012

(30) Foreign Application Priority Data
Jun. 15, 2011 (JP) 2011-133505

(51) Int. Cl. G06F 21/00

(52) U.S. Cl. 713/189

(57) ABSTRACT

A novel information processing apparatus prevents unauthorized software from running with a hash value whose bit length is longer than each register in a transfer platform module 40 (TPM) using the TPM 40. The TPM 40 includes platform configuration register (PCR) 404-409 that stores a hash value calculated with software program code and a decoding unit 414 that determines the software is legitimate in case hash values stored in the PCR 404-409 match predefined value and decodes encrypted data. The information processing apparatus includes the TPM 40, a dividing unit 202 that divides the hash value and generates a plurality of bit strings that have a shorter bit length than the PCR 404-409, and a storing unit that has the TPM store each bit string in each of the PCRs 404-409.

### CROSS-REFERENCE TO RELATED APPLICATION

This patent application is based on and claims priority pursuant to 35 U.S.C. §119 to Japanese Patent Application No. 2011-133505, filed on Jun. 15, 2011, the entire disclosure of which is hereby incorporated by reference herein.

### BACKGROUND OF THE INVENTION

1. Field of the Invention

The present invention relates to an information processing apparatus, a verification method, and a storage medium that stores a software program implementing the verification method on a computer, and more particularly to an information processing apparatus, verification method, and storage medium storing a program that prevents hacked devices from working.

2. Description of the Related Art

Improving the security of computer-embedded apparatuses, such as image processing apparatuses and multi function peripherals (MFPs), is becoming a major issue. To cope with this problem, an approach is proposed that uses a security chip (security-specific integrated circuit) known as a trusted platform module (TPM) or TPM chip that prevents unauthorized software from working by executing a verification process that assures that only legitimate software guaranteed by the manufacturer works on an apparatus to protect user's personal information stored in the apparatus and prevent devices from being hacked.

FIG. 9 illustrates a verification process that uses TPM during booting up of a conventional information processing apparatus. The upper part of FIG. 9 illustrates a platform 70 of the information processing apparatus as hardware that includes a central processing unit (CPU) and other devices and facilitates running various software programs on the platform 70. As an example, in FIG. 9, three modules (programs)—a basic input/output system (BIOS) 72, a base package 74 that includes software such as operating system (OS), and an application package 76 that includes various application software—are loaded into volatile memory such as random access memory (RAM) from nonvolatile memory such as read only memory (ROM) that constructs the platform 70, and executed by CPU. The lower part of FIG. 9 illustrates a TPM 80 included in the information processing apparatus. The TPM 80 includes platform configuration registers (PCR) 82-84 that store hash values described later.

This information processing apparatus loads the BIOS 72 from the nonvolatile memory and executes it on the platform 70 during boot-up due to power on etc. At the same time, the BIOS 72 calculates its own hash values and stores them in the PCR 82 included in the TPM 80. The hash values are calculated by operating a special function called a hash function in program code. Every hash function calculates different hash values with different program code. Therefore, if a calculated hash value matches a hash value calculated in the past, it is determined that the program is the same unmodified program has not been modified. Conventionally, a function called SHA-1 is used as the hash function, and SHA-1 calculates a 160-bit (20-byte) hash value. It should be noted that the PCRs that store hash values for each program are predefined for each type of program.

Accordingly, the BIOS 72 calculates the hash value of the base package 74 that will be loaded next. Usually this hash value is calculated when the base package 74 is loaded into volatile memory from nonvolatile memory, and the calculated hash value is stored in the PCR 83. After calculating the hash value of the base package 74, the base package 74 loaded into the volatile memory is executed, and the base package 74 calculates hash value of the application package 76 that will be loaded next and stores the calculated hash value to the PCR 84, then the application package 74 is executed.

Accordingly, chain of trust (a chain of hash values calculated for each software layer) is built up from the bottom up as the BIOS 72, the base package 74, and the application package 76 sequentially store calculated hash values of each program to the PCRs 82-84.

Also, the TPM 80 has a unique built-in secret key, and this secret key cannot be removed unless the TPM 80 is physically broken. After inputting data to be encrypted (e.g., a user password) and a combination of values of the PCRs 82-84 that is the decoding condition for the data after encrypting, the TPM 80 encrypts the data using its unique secret key and outputs information that includes the encrypted data and the aforementioned decoding condition. This information is called a Blob.

The TPM 80 that includes the unique secret key used in encrypting the data can decode this encrypted data included in the Blob. That is to say, when the Blob is input to the TPM 80, the TPM 80 refers to the decoding condition in the Blob, that is, to the combination of values in the PCRs 82-84, and determines if the referred combination of values match the combination of values currently stored in the PCRs 82-84. If these combinations match, the TPM 80 decodes the encrypted data included in the Blob using its secret key and outputs the decoded data.

If combination of the PCR 82-84 values that consists of hash values calculated in advance for each legitimate (unmodified) BIOS 72, base package 74, and application package 76 is used as the decoding condition included in the Blob, the encrypted data is decoded only if these programs are legitimate. Accordingly, the TPM 80 can verify each software program using the decoding condition described above, and outputs decoded data after verification in case each program is legitimate. Also, in case secret information such as a user password is the data to be encrypted, the TPM 80 cannot verify the user password if the software program is not legitimate, thus preventing unauthorized software from executing.

FIGS. 10A and 10B illustrate data encrypting and decoding processes using TPM on conventional information processing apparatus. FIG. 10A illustrates the encrypting process and FIG. 10B illustrates the decoding process.

First, in the data encrypting process (FIG. 10A), data to be encrypted (DATA P) shown in the left side of FIG. 10A and a combination of values in PCRs 82-84, Q, R, and S, are input to the TPM 80. It should be noted that the values Q, R, and S, are hash values for each of the legitimate BIOS 72, the legitimate base package 74, and the legitimate application package 76 calculated in advance.

The TPM 80 encrypts the DATA P using its secret key based on input information shown above, and generates a Blob 90 that includes the encrypted DATA P and decoding conditions Q, R, and S. The generated Blob 90 is stored in, e.g., nonvolatile RAM (NVRAM) of the information processing apparatus.

Next, in the data decoding process (FIG. 10B), the above-generated Blob is input to the TPM 80. In FIG. 10B, Blobs 92-94 shown in the left side of FIG. 10B are input to the TPM 80.

The PCRs 82-84 inside the TPM 80 in the center of FIG. 10B each store one of the hash values Q, R, and S calculated for each of the BIOS 72, the base package 74, and the application package 76. Also, whether or not data included in each of the Blobs 92-94 is decoded is shown by circles and Xs in the right side of FIG. 10B.

The Blob 92 includes three values (Q, R, S) as combination of decoding condition PCRs 82-84, and since these values match the values currently stored in the PCRs 82-84 (Q, R, S), the TPM 80 decodes the DATA P included in the Blob 92 and outputs the decoded data.

By contrast, the Blob 93 includes three values (Q, T, S) as combination of decoding condition PCRs 82-84, and since these values do not match the values currently stored in the PCRs 82-84 (Q, R, S), the TPM 80 does not decode the DATA P included in the Blob 93.

Furthermore, the Blob 94 includes only one value (Q) of the PCR 82 as combination of decoding condition PCRs 82-84, and since this value matches the value Q currently stored in the PCR 82, the TPM 80 decodes DATA P included in the Blob 94.

As described above, the TPM 80 executes a verification process for each piece of software and decodes the encrypted data only if the software is legitimate, thus preventing unauthorized software from executing.

An information processing apparatus that uses TPM as described above is known that, to prevent Blob data generated using hash values of programs before update from not being able to be decoded in case the hash values of the programs are changed by updating, decodes data included in an existing Blob using the hash value of the program before update and regenerates the Blob by reencrypting the data using the hash value of the program after update (e.g., JP-2008-226159-A.)

As another example of an information processing apparatus that uses TPM, to store encrypted data in a storage device such as a hard disk drive (HDD), an information processing apparatus that stores an encryption key used for encrypting and decoding the data and encrypted by TPM in the Blob, acquires the encryption key from the Blob during reading/writing data from/to the storage device, and reads/writes data from/to the storage device using the acquired encryption key is known (e.g., JP-2008-234217-A.)

However, since the encryption method used widely in various information processing apparatuses as a de facto standard is at risk of being defeated as the processing power of computers increases, it is necessary to switch to an encryption method that is more difficult to defeat. Also, since the hash function SHA-1 used widely is at risk of being unable to detect tampering of transferred encrypted data, it is necessary to switch to a stronger hash function.

Against this background, the National Institute of Standards and Technology (NIST) decided that the existing encryption key (e.g., RSA) and hash function SHA-1 should be replaced by an encryption key with a longer bit length and a hash function that provides a hash value with longer bit length as the standard encryption method that the U.S. government adopts by Dec. 30, 2010, known as “Year 2010 Issues on Cryptographic Algorithms.”

Also, in Japan, the National Information Security Center (NISC) decided to adopt SHA-256 that provides 256-bit hash value in place of the existing SHA-1 that provides 160-bit hash value by about the year 2013.

However, at the time of application for patent on this invention, TPM Main Specification Level 2 Version 1.2, Revision 1.3 published by Trusted Computing Group (TCG) accepts hash function SHA-1 only, and handling hash value is limited to length under 160 bits (20 bytes). That is, the PCR in TPM can store a hash value whose maximum length is 160 bits and input interface to PCR is 160-bit in the TPM specification stated above, so hash function SHA-256 that provides a 256-bit (32-byte) hash value cannot be used in compliance with the TCG specification, and that means that it cannot solve the Year 2010 Issues described above.

### BRIEF SUMMARY OF THE INVENTION

The present invention provides a novel information processing apparatus, verification method, and storage medium with TPM that facilitate verification of software and encrypting/decoding storing data using hash value whose bit length is longer than bit length of PCR included in the TPM.

The present invention provides an information processing apparatus that has TPM that includes a register that stores a hash value calculated from program code and a decoding unit that determines that the software is legitimate if the hash value stored in the register matches predefined value and decodes encrypted data, a dividing unit that divides the hash value and generates a plurality of bit strings that have a bit length shorter than the register, and a storing unit that inputs the plurality of bit strings into the TPM and has the TPM store those bit strings in a corresponding register.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating a configuration of an image forming apparatus of the present invention.

FIG. 2 is a diagram illustrating a configuration of a main controller as an information processing apparatus in the image forming apparatus in FIG. 1.

FIG. 3 is a diagram illustrating storing process of hash value at boot sequence in the image forming apparatus in FIG. 1.

FIG. 4A and FIG. 4B are diagrams illustrating data encrypting/decoding process in the image forming apparatus in FIG. 1.

FIG. 5 is a flowchart illustrating steps of hash value recording process at boot sequence in the image forming apparatus in FIG. 1.

FIG. 6 is a flowchart illustrating a Blob generating process in the image forming apparatus in FIG. 1.

FIG. 7 is a flowchart illustrating a data saving process in the image forming apparatus in FIG. 1.

FIG. 8 is a flowchart illustrating a data reading process in the image forming apparatus in FIG. 1.

FIG. 9 is a diagram illustrating a flow of verification process at boot sequence in existing information processing apparatus using TPM.

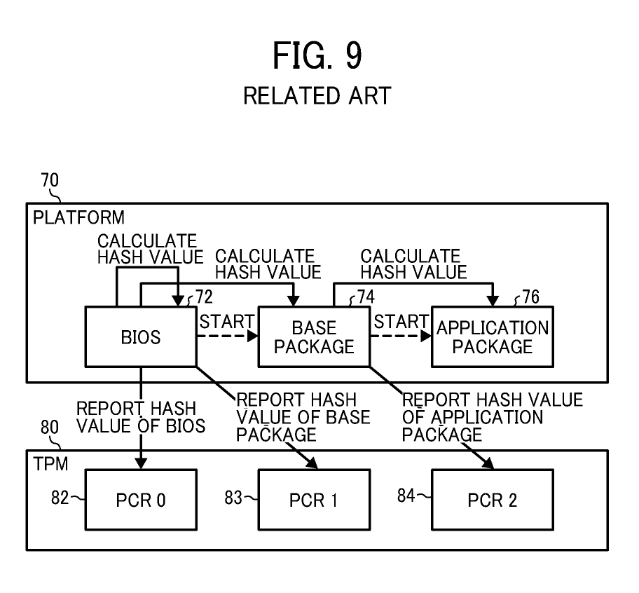

FIG. 10A and FIG. 10B are diagrams illustrating data encrypting/decoding process in a conventional information processing apparatus using TPM.

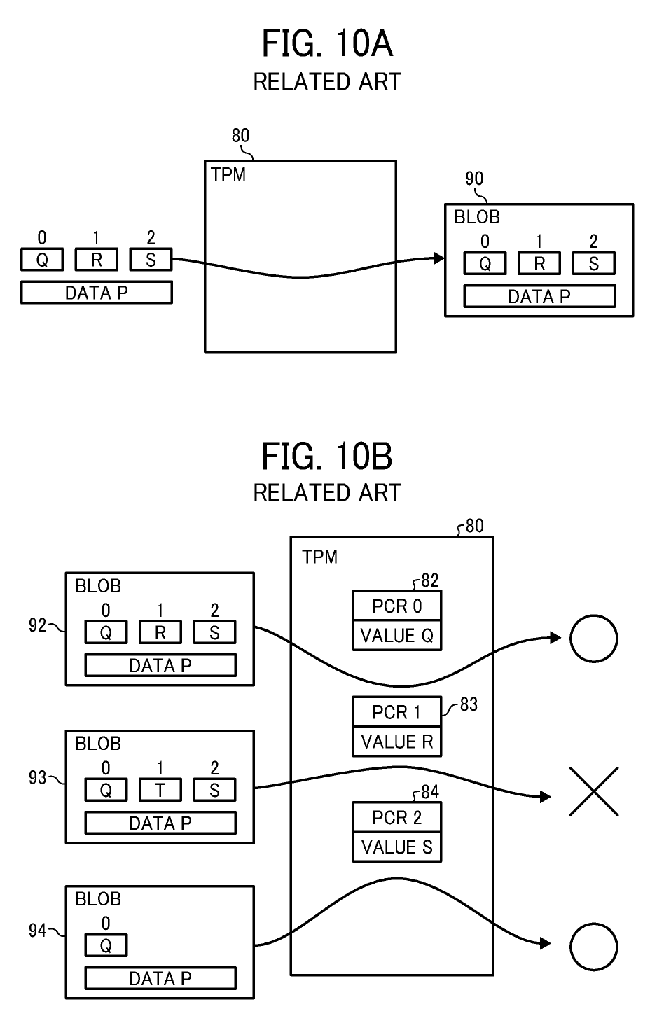

### DETAILED DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

An embodiment of the present invention will be described in detail below with reference to the drawings.

An image forming apparatus of the embodiment includes a computer that controls processes such as printing process (information processing apparatus), and the information processing apparatus includes a TPM with 160-bit length PCR that supports hash function SHA-1 only. The image forming apparatus calculates 256-bit length hash value of a software program using hash function SHA-256, generates two bit strings with 128-bit length by dividing the hash value, and stores each bit string to each of two 160-bit length PCRs described above as individual hash value.

Also, the image forming apparatus divides hash value for the legitimate software program calculated in advance, generates two bit strings with 128-bit length by dividing the hash value as described above, and generates Blob with these two values that the two bit strings show as decoding condition, verification conditions for the software in other words.

That is, the image forming apparatus stores hash value of software to be verified legitimateness using a pair of PCRs for each piece of software, generates Blob setting decoding condition for each pair of PCRs, and verifies legitimateness based on 256-bit hash value using existing TPM chip that supports 160-bit hash value only.

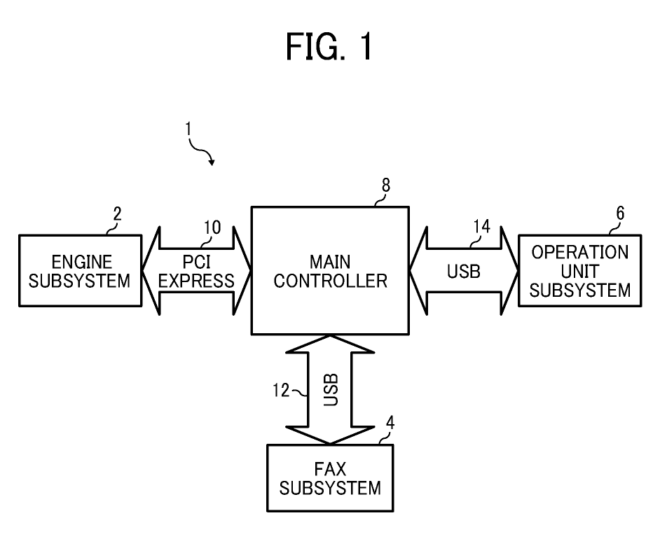

FIG. 1 is a block diagram illustrating a configuration of an image forming apparatus of the present invention. The image forming apparatus 1 is a MFP with printing function, scanning function, and faxing function, and includes an engine subsystem 2 that forms images on a printing sheet and scans a document using a printer (not shown in figures) and scanner (not shown in figures), a facsimile subsystem 4 that executes facsimile communication via public network using facsimile unit (not shown in figures), an operation unit subsystem 6 that acquires input from users using input devices such as operational keyboard (not shown in figures), and a main controller 8 as an information processing apparatus that controls operation of these three subsystems as a whole.

Also, a PCIe bus 10, serial bus compliant with PCI express specification, connects the main controller 8 with the engine subsystem 2. A USB bus 12, serial bus compliant with Universal Serial Bus (USB) specification, connects the main controller 8 with the facsimile subsystem 4, and a USB bus 14 connects the main controller 8 with the operation unit subsystem 6.

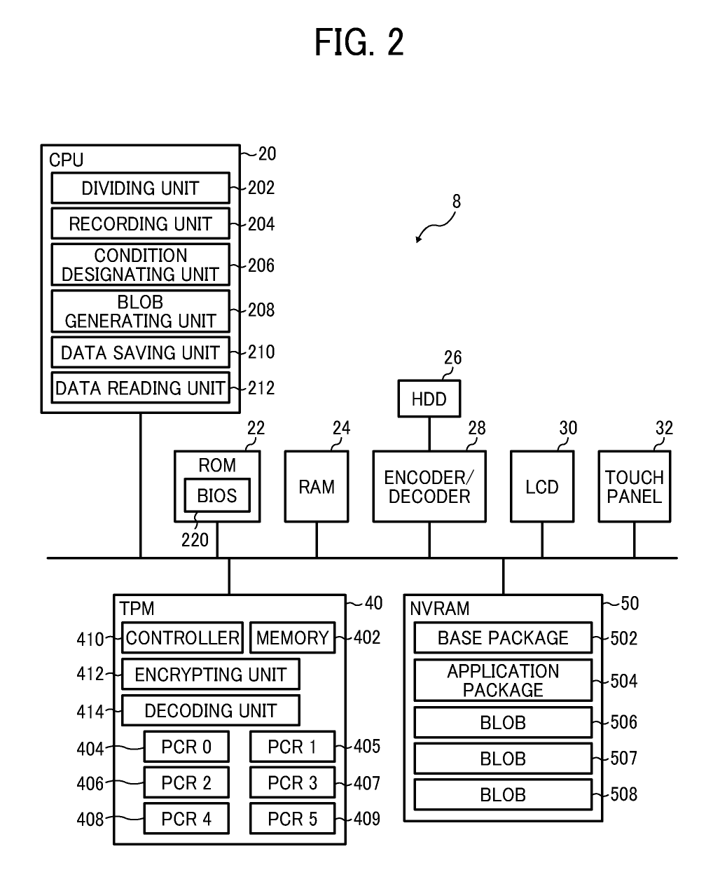

FIG. 2 is a diagram illustrating a configuration of a main controller 8 as an information processing apparatus in the image forming apparatus 1. The main controller 8 includes a computer with a CPU 20, a ROM 22 that includes programs such as BIOS 220 executed at boot-up of the CPU 20, a RAM 24 that stores data temporarily, a HDD 26 that stores data, an encoder/decoder 28 that encrypts data stored in the HDD 26 and decodes data read from the HDD 26, a liquid crystal display (LCD) 30 that displays data, etc., for users, and a touch panel 32 allocated on display surface of the LCD 30 and used to input data, etc., by users.

Also, the main controller 8 includes a TPM 40, a security chip that executes verification process etc. for software run by the CPU 20, and a NVRAM 50 that stores various software programs.

The TPM 40 includes a memory 402 that stores secret key for encrypting input data, PCR 404-409, registers that store hash values that the CPU 20 calculates on software programs such as BIOS 220, a controller 410 that controls operation of TPM 40 inside, an encrypting unit 412 that encrypts input data using the secret key, and a decoding unit 414 that decodes encrypted data in input Blob using the secret key in case decoding condition included in the Blob is satisfied.

It should be noted that the TPM 40 supports 160-bit hash value that hash function SHA-1 generates only, and maximum bit length of hash value that the PCR 404-409 can store (bit length of PCR 404-409) is 160 bits.

The NVRAM 50 stores a base package 502 that is a software program including OS, an application package 504 that includes software programs to have a printer (not shown in figures) and a scanner (not shown in figures) controlled by the engine subsystem 2 and facsimile unit (not shown in figures) controlled by the facsimile subsystem 4 work, and Blob 506-508 generated by the TPM 40. Also, the Blob 506 stores encrypted secret key to encrypt/decode data when the data is saved to the HDD 26 and read from the HDD 26.

The main controller 8 includes a dividing unit 202, a storing unit 204, a condition designating unit 206, a Blob generating unit 208, a data saving unit 210, and a data reading unit 212. Those units in the main controller 8 are implemented by executing computer programs stored in the ROM 22 or the NVRAM 50 by the CPU 20, and computer programs can be stored on a computer-readable storage medium.

The dividing unit 202 divides bit string of 256-bit hash value for each software program calculated by the CPU 20 using hash function SHA-256 based on BIOS etc. into upper 128-bit bit string and lower 128-bit bit string. It should be noted that dividing method is not limited to that described above. Any dividing method that makes the length of the divided bit string less than bit length of PCR 404-409 (160-bit) will work.

The storing unit 204 inputs two 128-bit bit strings generated by the dividing unit 202 as individual hash value into the TPM 40, and has the TPM 40 store them into any two PCRs of PCR 404-409 that the TPM 40 includes.

The condition designating unit 206 inputs hash value in case of legitimate software program as decoding condition (verification conditions) when the Blob generating unit 208 generates Blob using the TPM 40. It should be noted that hash function SHA-256 provides the hash value in case of legitimate software program as 256-bit value, so the condition designating unit 206 generates two 128-bit bit strings by dividing the hash value in case of legitimate in the same way as the dividing unit 202 does, and inputs these two bit strings into the TPM 40 as verification conditions for the software.

The Blob generating unit 208 provides a hash value calculated for each legitimate software program to the condition designating unit 206, has the condition designating unit 206 input those two bit strings into the TPM 40, and generates a Blob by inputting data to be encrypted into the TPM 40.

At the time of executing the application package 504 etc. and saving data to the HDD 26, the data saving unit 210 inputs the Blob 506 into the TPM 40 after reading the Blob 506 from the NVRAM 50, and acquires the secret key included in the Blob 506 from the TPM 40. Also, the data saving unit 210 passes the acquired secret key to the encoder/decoder 28, has the encoder/decoder 28 encrypt data to be saved, and saves the encrypted data into the HDD 26.

At the time of executing the application package 504 etc. and saving data to the HDD 26, the data reading unit 212 inputs the Blob 506 into the TPM 40 after reading the Blob 506 from the NVRAM 50, and acquires secret key included in the Blob 506 from the TPM 40. Also, the data reading unit 212 passes the acquired secret key to the encoder/decoder 28, has the encoder/decoder 28 decode data read from the HDD 26, and acquires the plain (unencrypted) data.

After turning the power on, the image forming apparatus described above has the CPU 20 execute the BIOS 220 stored in the ROM 22, the base package 502, and the application package 504 stored in the NVRAM 50 sequentially after loading them into the RAM 24. On that occasion, the CPU 20 calculates hash values of the BIOS 220, the base package 502, and the application package 504 by executing the BIOS 220 and the base package 504, and stores those hash values into the PCR 404-409 in the TPM 40.

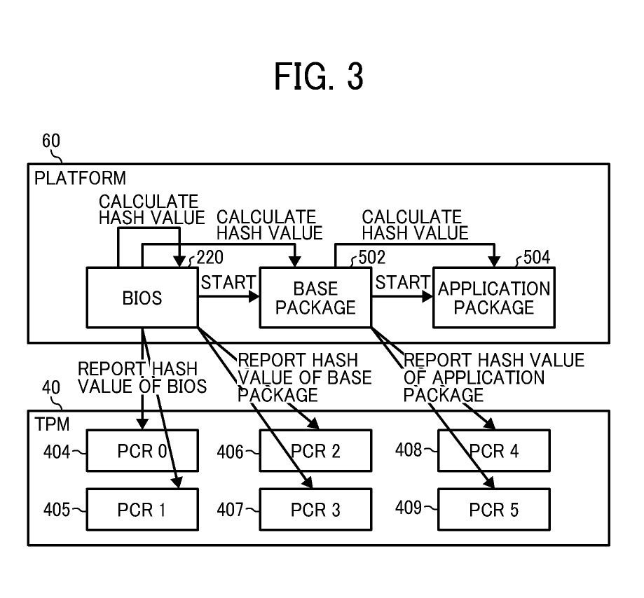

FIG. 3 is a diagram illustrating storing process of hash values at boot-up of the image forming apparatus 1. The upper part of FIG. 3 illustrates the platform 60 of the main controller 8 as overall hardware basis to run programs including the CPU 20 and so on, and the BIOS 220, the base package 502, and the application package 504 are executed on the platform 60. The lower part of FIG. 3 illustrates the PCR 404-409 of the TPM 40.

The biggest difference between hash value storing process using the image forming apparatus 1 in FIG. 3 and hash value storing process using conventional information processing apparatuses is to use SHA-256 to calculate hash value and store each 256-bit hash value using a pair of PCRs in FIG. 3. Also, regarding hash value reporting (hash value inputting) to the TPM 40, 256-bit hash value is divided into (for example) two 128-bit bit strings, and these two bit strings are reported (inputted) as two hash values separately.

After turning the power on, in the image forming apparatus 1, the CPU 20 starts executing the BIOS 220 and calculates hash value of the BIOS 220 itself using hash function SHA-256. Subsequently, the calculated 256-bit hash value is divided into two 128-bit bit strings, and one bit string is stored in the PCR 404 and the PCR 405 after inputting each bit string into the TPM 40 as an individual hash value. Next, the BIOS 220 calculates the hash value of the base package 502 to be executed next using hash function SHA-256, divides the hash value into two 128-bit bit strings as described above, stores one bit string into each of the PCRs 406-407 in the TPM 40, and executes the base package 502.

Subsequently, the base package 502 calculates hash value of the application package 504 to be executed next using hash function SHA-256, divides the hash value into two 128-bit bit strings as described above, stores one bit string into each of the PCR 408-409, and executes the application package 504.

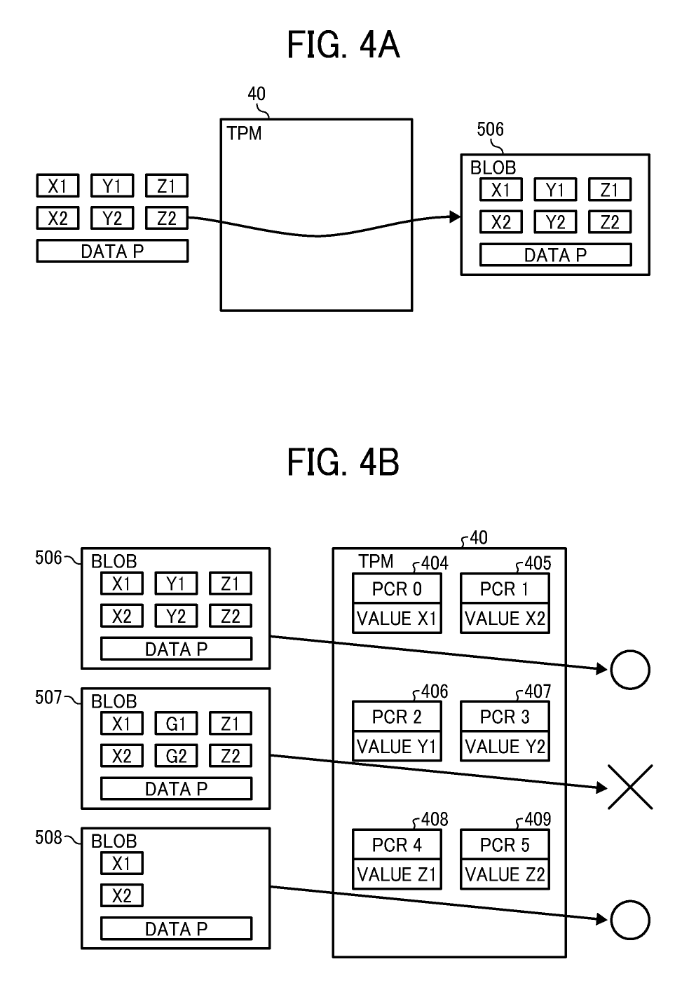

Also, the image forming apparatus 1 encrypts/decodes data that includes secret information such as user password using the TPM 40. FIG. 4A and FIG. 4B are diagrams illustrating data encrypting/decoding process in the image forming apparatus 1. FIG. 4A illustrates encrypting process and FIG. 4B illustrates decoding process.

In FIG. 4A (data encrypting process), data to be encrypted (DATA P) shown in the left side of FIGS. 4A and X1, X2, Y1, Y2, Z1, Z2 that are combination of values in the PCR 404-409 as decoding conditions of DATA P are input to the TPM 40. X1 and X2 are two values generated by dividing 256-bit hash value in case the BIOS 220 is legitimate into two 128-bit bit strings. Y1 and Y2 are two values generated by dividing 256-bit hash value in case the base package 502 is legitimate into two 128-bit bit strings. Z1 and Z2 are two values generated by dividing 256-bit hash value in case the application package 504 is legitimate into two 128-bit bit strings.

The TPM 40 encrypts DATA P using secret key stored in the memory 402 of the TPM 40 and generates the Blob 506 that includes the encrypted DATA P and X1, X2, Y1, Y2, Z1, and Z2 as decoding condition based on input information described above. It should be noted that the Blob 506 is generated with DATA P described above as secret key used to encrypt/decode data to be stored in the HDD 26 in the embodiment. Also, the encrypting process described above is executed when a user inputs secret information such as a user password and secret key as initial settings at the first boot sequence of the image forming apparatus 1 for example.

Next, in FIG. 4B (data decoding process), each of the Blob 506-508 shown in the left side of FIG. 4B is input to the TPM 40. Each of X1 and X2 generated by dividing hash value of the BIOS 220, Y1 and Y2 generated by dividing hash value of the base package 502, and Z1 and Z2 generated by dividing hash value of the application package 504 is stored in each of the PCR 404-409. Furthermore, whether or not each data included in each of the Blob 506-508 is decoded is shown using circles and Xs in the right side of FIG. 4B.

The Blob 506 includes six values (X1, X2, Y1, Y2, Z1, Z2) as combination of decoding condition PCR 404-409, and since these values match values currently stored in the PCR 404-409, the TPM 80 decodes the DATA P included in the Blob 506 and outputs the decoded data. By contrast, the Blob 507 includes six values (X1, X2, G1, G2, Z1, Z2) as combination of decoding condition, and since these values do not match values currently stored in the PCR 404-409 (X1, X2, Y1, Y2, Z1, Z2), the TPM 80 does not decode the DATA P included in the Blob 507. Furthermore, the Blob 508 includes only two values (X1, X2) of the PCR 404-405 as combination of decoding condition, and since these values match values X1 and X2 currently stored in the PCR 404-405, the TPM 80 decodes DATA P included in the Blob 508.

Next, operating sequence of the image forming apparatus 1 is described below. The image forming apparatus 1 executes hash value storing process that calculates hash value of software program at the time of its execution and stores the hash value in the PCR 404-409 in the TPM 40, Blob generating process that encrypts secret information at the first time of execution and generates Blob, data saving process that encrypts data to be saved and save the data into the HDD 26 during the execution of application software included in the application package 504, and data reading process that reads data stored in the HDD 26 and decodes the data.

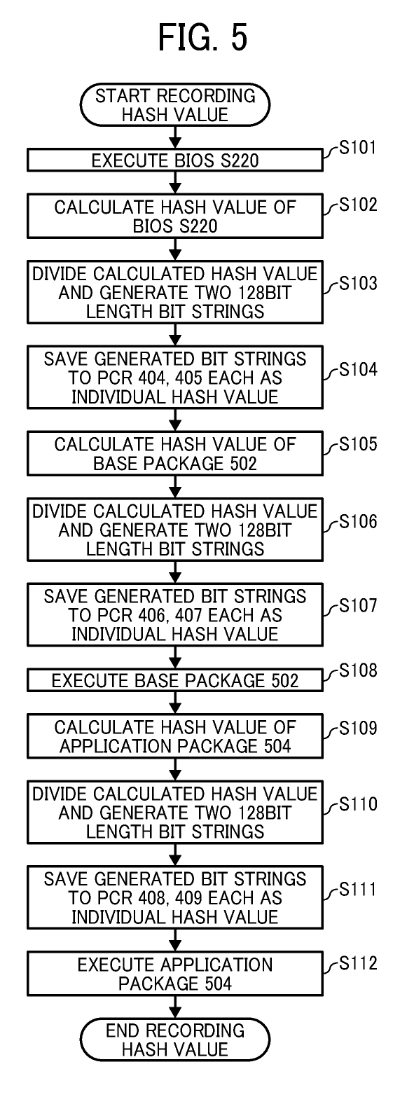

First, procedure of hash value recording process on start-up of the image forming apparatus 1 is described with reference to flowchart in FIG. 5. When a user turns the power of the image forming apparatus 1 on, the CPU 20 loads the BIOS 220 stored in the ROM 22 to the RAM 24 and executes the BIOS 220 (S101), and calculates the hash value of the BIOS 220 itself using hash function SHA-256 (S102). Next, the dividing unit 202 generates two 128-bit bit strings by dividing the calculated hash value (S103), and the storing unit 204 inputs the two generated bit strings to the TPM 40 as individual hash value and has the TPM 40 store each of the bit strings to one of the PCR 404-405 (S104).

Next, the CPU 20 calculates hash values of the base package 502 using hash function SHA-256 based on the program in the BIOS 220 (S105), and the dividing unit 202 divides the calculated hash value and generates two bit strings with 128-bit length (S106). Subsequently, the storing unit 204 inputs the two generated bit strings to the TPM 40 as individual hash value, has the TPM 40 store each of the bit strings to each of the PCR 406-407 (S107), and executes the base package 502 (S108).

Next, the CPU 20 calculates hash values of the application package 504 using hash function SHA-256 based on the program in the base package 502 (S109), and the dividing unit 202 divides the calculated hash value and generates two bit strings with 128-bit length (S110). Subsequently, the storing unit 204 inputs the two generated bit strings to the TPM 40 as individual hash value, has the TPM 40 store each of the bit strings to each of the PCR 408-409 (S111), executes the application package 504 (S112), and finishes these processes.

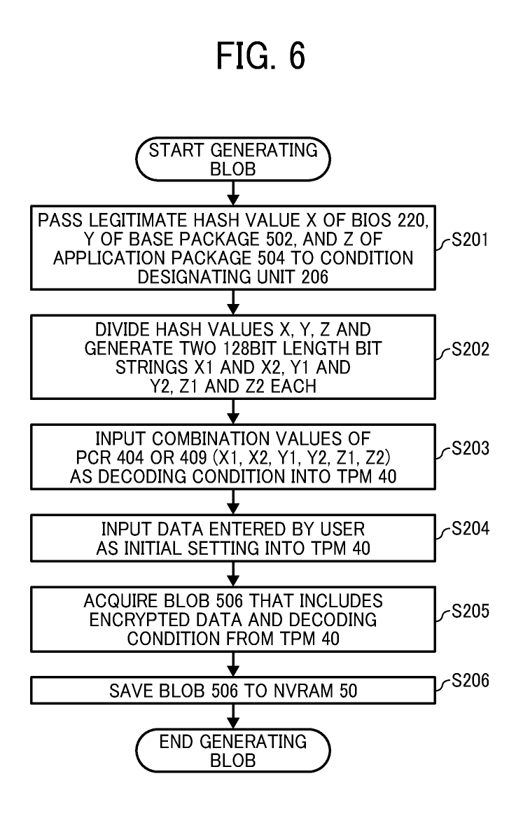

Next, procedure of Blob generating process in the image forming apparatus 1 is described with reference to flowchart in FIG. 6. This procedure starts when a user inputs data that is secret information as initial setting at the first start-up of the image forming apparatus 1.

After starting the procedure, the Blob generating unit 208 passes hash value X of the unmodified and legitimate BIOS 220, hash value Y of the legitimate base package 502, and hash value Z of the legitimate application package 504 to the condition designating unit 206 (S201). It should be noted that these hash values X, Y, and Z can be preliminarily calculated and included in program.

Next, the condition designating unit 206 divides hash values X, Y, and Z, generates each pair of 128-bit length bit strings X1 and X2, Y1 and Y2, and Z1 and Z2 (S202), and inputs combination of values in the PCR 404-409 (X1, X2, Y1, Y2, Z1, Z2) to the TPM 40 as the decoding condition (S203). The Blob generating unit 208 inputs data that the user entered as the initial setting to the TPM 40 (S204). It should be noted that the data entered by the user is encryption key to encrypt/decode data stored in the HDD 26 in this embodiment.

Accordingly, the TPM 40 encrypts the input data (encryption key) using secret key stored in the memory 402, and outputs the Blob 506 that includes the encrypted data and the input decoding condition described above. Next, the Blob generating unit 208 acquires the Blob 506 from the TPM 40 (S205), stores the acquired Blob 506 in the NVRAM 50 (S206), and finishes these processes.

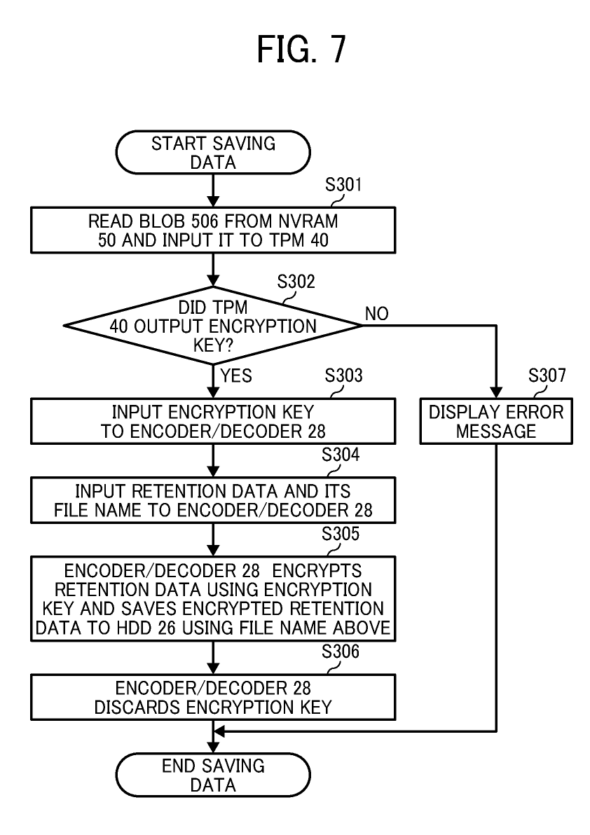

Next, procedure of data saving process in the image forming apparatus 1 is described with reference to flowchart in FIG. 7. This procedure starts when application software included in the application package 504 saves data in the HDD 26 during its execution.

After starting the procedure, the data saving unit 210 reads the Blob 506 from the NVRAM 50 and inputs the Blob 506 to the TPM 40 (S301).

Subsequently, the TPM 40 determines whether or not the decoding condition included in the input Blob 506, more specifically combination of values in the PCR 404-409 (X1, X2, Y1, Y2, Z1, Z2) matches the combination of values currently stored in the PCR 404-409. If it matches, the TPM 40 decodes the encrypted data (encryption key) included in the Blob 506 using the secret key stored in the memory 402, and outputs the decoded data. If it does not match, the TPM 40 outputs a predefined error code for example.

Next, the data saving unit 210 determines whether or not the TPM 40 has output the encryption key (S302). If the TPM 40 did output the encryption key (S302:Yes), the data saving unit 210 inputs the output encryption key to the encoder/decoder 28 (S303) and inputs data to be stored in the HDD 26 and its file name to the encoder/decoder 28 (S304).

Next, the encoder/decoder 28 encrypts the data to be stored using the encryption key, has the HDD 26 store the encrypted data using the file name described above (S305), discards the encryption key (S306), and finishes these processes.

By contrast, if the TPM 40 did not output the encryption key in S302 (S302:No), the data saving unit 210 displays error message on the LCD 30 (S307) and finishes these processes.

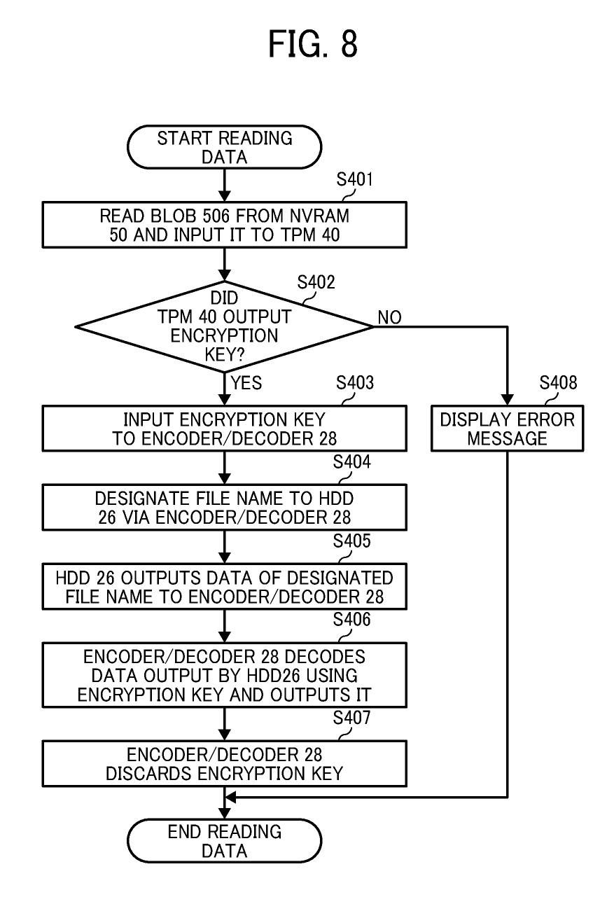

Next, procedure of data reading process in the image forming apparatus 1 is described with reference to the flowchart in FIG. 8. This procedure starts when application software included in the application package 504 reads data from the HDD 26 during its execution.

After starting the procedure, the data reading unit 212 reads the Blob 506 from the NVRAM 50 and inputs the Blob 506 to the TPM 40 (S401).

Next, the data reading unit 212 determines whether or not the TPM 40 has output the encryption key (S402). If the TPM 40 did output the encryption key (S402:Yes), the data reading unit 212 inputs the output the encryption key to the encoder/decoder 28 (S403) and provides the HDD 26 with the file name of data to be read via the encoder/decoder 28 (S404).

Subsequently, the HDD 26 inputs data stored with the provided file name to the encoder/decoder 28 (S405), and the HDD 26 decodes the data output by the HDD 26 using the encryption key, outputs the decoded data (S406), discards the encryption key (S407), and finishes these processes.

By contrast, if the TPM 40 did not output the encryption key in S402 (S402:No), the data reading unit 212 displays error message on the LCD 30 (S408) and finishes these processes.

As described above, in this embodiment, 256-bit hash value generated for each piece of software to be verified by hash function SHA-256 is divided into two 128-bit length bit strings, and the generated bit strings are stored in two PCRs among the PCRs 404-409. Also, when the Blob is generated, 256-bit hash value for the legitimate software program is divided as described above, and the thus-acquired pair of values is input to the TPM 40 as decoding conditions of encrypted data (specifically verification conditions).

Accordingly, the image forming apparatus 1 can verify with 256-bit hash value generated by “Year 2010 Issues on Cryptographic Algorithms” compliant hash function SHA-256 using the TPM 40 that supports 160-bit hash value generated by hash function SHA-1 only.

Also, while configuration with a MFP is described as an example in this embodiment, the invention can be applied to any system that includes subsystem that has function to verify with TPM and controlled by software examined legitimateness with the function.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application specific integrated circuits or by interconnecting an appropriate network of conventional component circuits, as will be readily apparent to those skilled in the relevant art.

What is claimed is:

1. A information processing apparatus, comprising:
a transfer platform module (TPM) comprising:
a register that stores a hash value calculated from software program code; and
a decoding unit that determines that the software is legitimate if the hash value stored in the register matches a predefined value and decodes encrypted data;
a dividing unit to divide the hash value and generate a plurality of bit strings that have a shorter bit length than the bit length of the register; and
a storing unit to input the plurality of bit strings into the TPM and cause the TPM to store each bit string in a corresponding register.

2. The information processing apparatus according to claim 1, further comprising a condition designating unit to input the predefined value for each register that stores the plurality of bit strings to the TPM for each piece of software.

3. A method of verifying an information processing apparatus,
the information processing apparatus including a transfer platform module (TPM) comprising a register that stores a hash value calculated from software program code and a decoding unit that determines that the software is legitimate if the hash value stored in the register matches a predefined value and decodes encrypted data,
the method comprising the steps of:
dividing the hash value and generating a plurality of bit strings that have a shorter bit length than the bit length of the register; and
inputting the plurality of bit strings into the TPM and causing the TPM to store each bit string in a corresponding register.

4. A non-transitory computer-readable storage medium storing a program that, when executed by a computer, causes the computer to implement a method of verifying an information processing apparatus,
the method comprising the steps of:
dividing a hash value to generate a plurality of bit strings that have a shorter bit length than the bit length of a register in which each bit string is stored; and
inputting the plurality of bit strings into the TPM and causing the TPM to store each bit string in a corresponding register.
